(19) United States
(12) Patent Application Publication
(10) Pub. No.: US 2023/0316588 A1
(43) Pub. Date: Oct. 5, 2023

(54) ONLINE TRAINING-BASED ENCODER TUNING WITH MULTI MODEL SELECTION IN NEURAL IMAGE COMPRESSION

(71) Applicant: Tencent America LLC, Palo Alto, CA (US)

(72) Inventors: Ding Ding, Washington, DC (US); Xiaozhong XU, State College, PA (US); Shan LIU, San Jose, CA (US)

(73) Assignee: Tencent America LLC, Palo Alto, CA (US)

(21) Appl. No.: 18/122,651

(22) Filed: Mar. 16, 2023

Related U.S. Application Data
(60) Provisional application No. 63/325,115, filed on Mar. 29, 2022.

(51) Int. Cl. G06T 9/00

(52) U.S. Cl. CPC G06T 9/002

(57) ABSTRACT

An apparatus for image/video encoding includes processing circuitry. The processing circuitry performs, based on one or more input images, respective online training based encoder tunings on a plurality of neural image compression (NIC) frameworks. An online training based encoder tuning on an NIC framework in the plurality of NIC frameworks determines an update to an encoder of the NIC framework with a decoder of the NIC framework having fixed parameters. The processing circuitry selects a first NIC framework based on respective performances of the plurality of NIC frameworks with updated encoders from the online training based encoder tunings. The first NIC framework has a first updated encoder from the online training based encoder tunings. The processing circuitry encodes, by the first updated encoder, the one or more input images, into a coded bitstream and includes a signal indicative of the first NIC framework in the coded bitstream.

### INCORPORATION BY REFERENCE

This present disclosure claims the benefit of priority to U.S. Provisional Application No. 63/325,115, “Online Training-based Encoder Tuning with multi model selection in Neural Image Compression” filed on Mar. 29, 2022, which is incorporated by reference herein in its entirety.

### TECHNICAL FIELD

The present disclosure describes embodiments generally related to image/video processing.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video files across different devices, storage and networks with minimal quality degradation. Improving image/video compression tools can require a lot of expertise, efforts and time. Machine learning techniques can be applied in the image/video compression to simply and accelerate the improvement of compression tools.

### SUMMARY

Aspects of the disclosure provide methods and apparatuses for image/video encoding and decoding. In some examples, an apparatus for image/video encoding includes processing circuitry. The processing circuitry performs, based on one or more input images, respective online training based encoder tunings on a plurality of neural image compression (NIC) frameworks. Each of the plurality of NIC framework corresponds to an end-to-end NIC model with a respective encoder and a respective decoder. An online training based encoder tuning on an NIC framework in the plurality of NIC frameworks determines an update to an encoder of the NIC framework with a decoder of the NIC framework having fixed parameters. The processing circuitry selects a first NIC framework from the plurality of NIC frameworks based on respective performances of the plurality of NIC frameworks with updated encoders from the online training based encoder tunings. The first NIC framework has a first updated encoder from the online training based encoder tunings. The processing circuitry encodes, by the first updated encoder of the first NIC framework, the one or more input images, into a coded bitstream and includes a signal indicative of the first NIC framework in the coded bitstream.

In some examples, the encoder of the NIC framework comprises a main encoder network, a hyper encoder network and a hyper decoder network, and the decoder of the NIC framework comprises the hyper decoder network and a main decoder network. In an example, the update to the encoder of the NIC framework includes at least a value change to a tunable parameter in at least one of the main encoder network and the hyper encoder network. In some examples, parameters of the main decoder network and the hyper decoder network are fixed at pretrained values learned from an offline training of the NIC framework.

In some examples, the plurality of NIC frameworks form a set of NIC frameworks, and the signal includes an index indicative of the first NIC framework in the set of NIC frameworks.

In some examples, at least two NIC frameworks in the plurality of NIC frameworks have different neural network structures.

In some examples, at least two NIC frameworks in the plurality of NIC frameworks have a same network structure, and have different pretrained parameters.

In some examples, at least two NIC frameworks in the plurality of NIC frameworks are pretrained based on different sets of training data.

In some examples, the processing circuitry selects the first NIC framework in response to the first NIC framework with the first updated encoder achieving a least loss performance. The least loss performance can be one of a least rate loss, a least distortion loss, and a least rate distortion loss.

Aspects of the disclosure also provide a non-transitory computer-readable storage medium storing a program executable by at least one processor to perform the methods for image/video encoding and/or decoding.

### BRIEF DESCRIPTION OF THE DRAWINGS

Further features, the nature, and various advantages of the disclosed subject matter will be more apparent from the following detailed description and the accompanying drawings in which:

FIG. 1 shows a neural image compression (NIC) framework in some examples.

FIG. 2 shows an example of a main encoder network in some examples.

FIG. 3 shows an example of a main decoder network in some examples.

FIG. 4 shows an example of a hyper encoder network in some examples.

FIG. 5 shows an example of a hyper decoder network in some examples.

FIG. 6 shows an example of a context model neural network in some examples.

FIG. 7 shows an example of an entropy parameter neural network in some examples.

FIG. 8 shows an image encoder in some examples.

FIG. 9 shows an image decoder in some examples.

FIGS. 10-11 show an image encoder and a corresponding image decoder in some examples.

FIG. 12 shows an example of a block-wise image coding in some examples.

FIGS. 13A and 13B show a block diagram of an electronic device in some examples.

FIG. 14 shows a diagram of an electronic device in some examples.

FIG. 15 shows an image coding system in some examples.

FIG. 16 shows an encoding device in some examples.

FIG. 17 shows a flow chart outlining a process in some examples.

FIG. 18 shows a flow chart outlining a process in some examples.

FIG. 19 is a schematic illustration of a computer system in some examples.

### DETAILED DESCRIPTION OF EMBODIMENTS

According to an aspect of the disclosure, some video codecs can be difficult to be optimized as a whole. For example, an improvement of a single module (e.g., an encoder) in the video codec may not result in a coding gain in the overall performance. In contrast, in an artificial neural network (ANN) based video/image coding framework, a machine learning process can be performed, then different modules of the ANN based video/image coding framework can be jointly optimized from input to output to improve a final objective (e.g., rate-distortion performance, such as a rate-distortion loss L described in the disclosure). For example, a learning process or a training process (e.g., a machine learning process) can be performed on an ANN based video/image coding framework to optimize modules of the ANN based video/image coding framework jointly to achieve an overall optimized rate-distortion performance, and thus the optimization result can be an end to end (E2E) optimized neural image compression (NIC).

In the following description, the ANN based video/image coding framework is illustrated by a neural image compression (NIC) framework. While image compression (e.g., encoding and decoding) is illustrated in the following description, it is noted that the techniques for image compression can be suitably applied for video compression.

According to some aspects of the disclosure, an NIC framework can be trained in an offline training process and/or an online training process. In the offline training process, a set of training images that are collected previously can be used to train the NIC framework to optimize the NIC framework. In some examples, the determined parameters of the NIC framework by the offline training process can be referred to as pretrained parameters, and the NIC framework with the pretrained parameters can be referred to as pretrained NIC framework. The pretrained NIC framework can be used for image compression operations.

In some examples, when one or more images (also referred to as one or more target images) are available for an image compression operation, the pretrained NIC framework is further trained based on the one or more target images in an online training process to tune parameters of the NIC framework. The tuned parameters of the NIC framework by the online training process can be referred to as online trained parameters, and the NIC framework with the online trained parameters can be referred to as online trained NIC framework. The online trained NIC framework can then perform the image compression operation on the one or more target images. Some aspects of the disclosure provide techniques for online training based encoder tuning in neural image compression.

A neural network refers to a computational architecture that models a biological brain. The neural network can be a model implemented in software or hardware that emulates computing power of a biological system by using a large number of artificial neurons connected via connection lines. The artificial neurons referred to as nodes are connected to each other and operate collectively to process input data. A neural network (NN) is also known as artificial neural network (ANN).

Nodes in an ANN can be organized in any suitable architecture. In some embodiments, nodes in an ANN are organized in layers including an input layer that receives input signal(s) to the ANN and an output layer that outputs output signal(s) from the ANN. In an embodiment, the ANN further includes layer(s) that may be referred to as hidden layer(s) between the input layer and the output layer. Different layers may perform different kinds of transformations on respective inputs of the different layers. Signals can travel from the input layer to the output layer.

An ANN with multiple layers between an input layer and an output layer can be referred to as a deep neural network (DNN). DNN can have any suitable structures. In some examples, a DNN is configured in a feedforward network structure where data flows from the input layer to the output layer without looping back. In some examples, a DNN is configured in a fully connected network structure where each node in one layer is connected to all nodes in the next layer. In some examples, a DNN is configured in a recurrent neural network (RNN) structure where data can flow in any direction.

An ANN with at least a convolution layer that performs convolution operation can be referred to as a convolution neural network (CNN). A CNN can include an input layer, an output layer, and hidden layer(s) between the input layer and the output layer. The hidden layer(s) can include convolutional layer(s) (e.g., used in an encoder) that perform convolutions, such as a two-dimensional (2D) convolution. In an embodiment, a 2D convolution performed in a convolution layer is between a convolution kernel (also referred to as a filter or channel, such as a 5×5 matrix) and an input signal (e.g., a 2D matrix such as a 2D block, a 256×256 matrix) to the convolution layer. The dimension of the convolution kernel (e.g., 5×5) is smaller than the dimension of the input signal (e.g., 256×256). During a convolution operation, dot product operations are performed on the convolution kernel and patches (e.g., 5×5 areas) in the input signal (e.g., a 256×256 matrix) of the same size as the convolution kernel to generate output signals for inputting to the next layer. A patch (e.g., a 5×5 area) in the input signal (e.g., a 256×256 matrix) that is of the size of the convolution kernel can be referred to as a receptive field for a respective node in the next layer.

During the convolution, a dot product of the convolution kernel and the corresponding receptive field in the input signal is calculated. The convolution kernel includes weights as elements, each element of the convolution kernel is a weight that is applied to a corresponding sample in the receptive field. For example, a convolution kernel represented by a 5×5 matrix has 25 weights. In some examples, a bias is applied to the output signal of the convolution layer, and the output signal is based on a sum of the dot product and the bias.

In some examples, the convolution kernel can shift along the input signal (e.g., a 2D matrix) by a size referred to as a stride, and thus the convolution operation generates a feature map or an activation map (e.g., another 2D matrix), which in turn contributes to an input of the next layer in the CNN. For example, the input signal is a 2D block having 256×256 samples, a stride is 2 samples (e.g., a stride of 2). For the stride of 2, the convolution kernel shifts along an X direction (e.g., a horizontal direction) and/or a Y direction (e.g., a vertical direction) by 2 samples.

In some examples, multiple convolution kernels can be applied in the same convolution layer to the input signal to generate multiple feature maps, respectively, where each feature map can represent a specific feature of the input signal. In some examples, a convolution kernel can correspond to a feature map. A convolution layer with N convolution kernels (or N channels), each convolution kernel having M×M samples, and a stride S can be specified as Conv: M×M cN sS. For example, a convolution layer with 192 convolution kernels (or 192 channels), each convolution kernel having 5×5 samples, and a stride of 2 is specified as Conv: 5×5 c192 s2. The hidden layer(s) can include deconvolutional layer(s) (e.g., used in a decoder) that perform deconvolutions, such as a 2D deconvolution. A deconvolution is an inverse of a convolution. A deconvolution layer with 192 deconvolution kernels (or 192 channels), each deconvolution kernel having 5×5 samples, and a stride of 2 is specified as DeConv: 5×5 c192 s2.

In a CNN, a relatively large number of nodes can share a same filter (e.g., same weights) and a same bias (if the bias is used), and thus a memory footprint can be reduced because a single bias and a single vector of weights can be used across all receptive fields that share the same filter. For example, for an input signal having 100×100 samples, a convolution layer with a convolution kernel having 5×5 samples has 25 learnable parameters (e.g., weights). If a bias is used, then one channel uses 26 learnable parameters (e.g., 25 weights and one bias). If the convolution layer has N convolution kernels, the total learnable parameters is 26×N. The number of learnable parameters is relatively small compared to a fully connected feedforward neural network layer. For example, for a fully connected feedforward layer, 100×100 (i.e., 10000) weights are used to generate a result signal for inputting to each node in the next layer. If the next layer has L nodes, then the total learnable parameters is 10000×L.

A CNN can further include one or more other layer(s), such as pooling layer(s), fully connected layer(s) that can connect every node in one layer to every node in another layer, normalization layer(s), and/or the like. Layers in a CNN can be arranged in any suitable order and in any suitable architecture (e.g., a feed-forward architecture, a recurrent architecture). In an example, a convolutional layer is followed by other layer(s), such as pooling layer(s), fully connected layer(s), normalization layer(s), and/or the like.

A pooling layer can be used to reduce dimensions of data by combining outputs from a plurality of nodes at one layer into a single node in the next layer. A pooling operation for a pooling layer having a feature map as an input is described below. The description can be suitably adapted to other input signals. The feature map can be divided into sub-regions (e.g., rectangular sub-regions), and features in the respective sub-regions can be independently down-sampled (or pooled) to a single value, for example, by taking an average value in an average pooling or a maximum value in a max pooling.

The pooling layer can perform a pooling, such as a local pooling, a global pooling, a max pooling, an average pooling, and/or the like. A pooling is a form of nonlinear down-sampling. A local pooling combines a small number of nodes (e.g., a local cluster of nodes, such as 2×2 nodes) in the feature map. A global pooling can combine all nodes, for example, of the feature map.

The pooling layer can reduce a size of the representation, and thus reduce a number of parameters, a memory footprint, and an amount of computation in a CNN. In an example, a pooling layer is inserted between successive convolutional layers in a CNN. In an example, a pooling layer is followed by an activation function, such as a rectified linear unit (ReLU) layer. In an example, a pooling layer is omitted between successive convolutional layers in a CNN.

A normalization layer can be an ReLU, a leaky ReLU, a generalized divisive normalization (GDN), an inverse GDN (IGDN), or the like. An ReLU can apply a non-saturating activation function to remove negative values from an input signal, such as a feature map, by setting the negative values to zero. A leaky ReLU can have a small slope (e.g., 0.01) for negative values instead of a flat slope (e.g., 0). Accordingly, if a value x is larger than 0, then an output from the leaky ReLU is x. Otherwise, the output from the leaky ReLU is the value x multiplied by the small slope (e.g., 0.01). In an example, the slope is determined before training, and thus is not learnt during training.

An NIC framework can correspond to a compression model for image compression. The NIC framework receives an input image x and outputs a reconstructed image x̅ corresponding to the input image x. The NIC framework can include a neural network encoder (e.g., an encoder based on neural networks such as DNNs) and a neural network decoder (e.g., a decoder based on neural networks such as DNNs). The input image x is provided as an input to the neural network encoder to compute a compressed representation (e.g., a compact representation) \hat{x} that can be compact, for example, for storage and transmission purposes. The compressed representation \hat{x} is provided as an input to the neural network decoder to generate the reconstructed image x̅. In various embodiments, the input image x and reconstructed image x̅ are in a spatial domain and the compressed representation \hat{x} is in a domain different from the spatial domain. In some examples, the compressed representation \hat{x} is quantized and entropy coded.

In some examples, an NIC framework can use a variational autoencoder (VAE) structure. In the VAE structure, the entire input image x can be input to the neural network encoder. The entire input image x can pass through a set of neural network layers (of the neural network encoder) that work as a black box to compute the compressed representation \hat{x}. The compressed representation \hat{x} is an output of the neural network encoder. The neural network decoder can take the entire compressed representation \hat{x} as an input. The compressed representation \hat{x} can pass through another set of neural network layers (of the neural network decoder) that work as another black box to compute the reconstructed image x̅. A rate-distortion (R-D) loss L (x, x̅, \hat{x}) can be optimized to achieve a trade-off between a distortion loss D (x, x̅) of the reconstructed image x̅ and bit consumption R of the compact representation \hat{x} with a trade-off hyperparameter λ, such as according to Eq. 1:

L(x, x̅, \hat{x})=λD(x, x̅)+R(\hat{x}) Eq. 1

A neural network (e.g., an ANN) can learn to perform tasks from examples, without task-specific programming. An ANN can be configured with connected nodes or artificial neurons. A connection between nodes can transmit a signal from a first node to a second node (e.g., a receiving node), and the signal can be modified by a weight which can be indicated by a weight coefficient for the connection. The receiving node can process signal(s) (i.e., input signal(s) for the receiving node) from node(s) that transmit the signal(s) to the receiving node and then generate an output signal by applying a function to the input signals. The function can be a linear function. In an example, the output signal is a weighted summation of the input signal(s). In an example, the output signal is further modified by a bias which can be indicated by a bias term, and thus the output signal is a sum of the bias and the weighted summation of the input signal(s). The function can include a nonlinear operation, for example, on the weighted sum or the sum of the bias and the weighted summation of the input signal(s). The output signal can be sent to node(s) (downstream node(s)) connected to the receiving node). The ANN can be represented or configured by parameters (e.g., weights of the connections and/or biases). The weights and/or the biases can be obtained by training (e.g., offline training, online training, and the like) the ANN with examples where the weights and/or the biases can be iteratively adjusted. The trained ANN configured with the determined weights and/or the determined biases can be used to perform tasks.

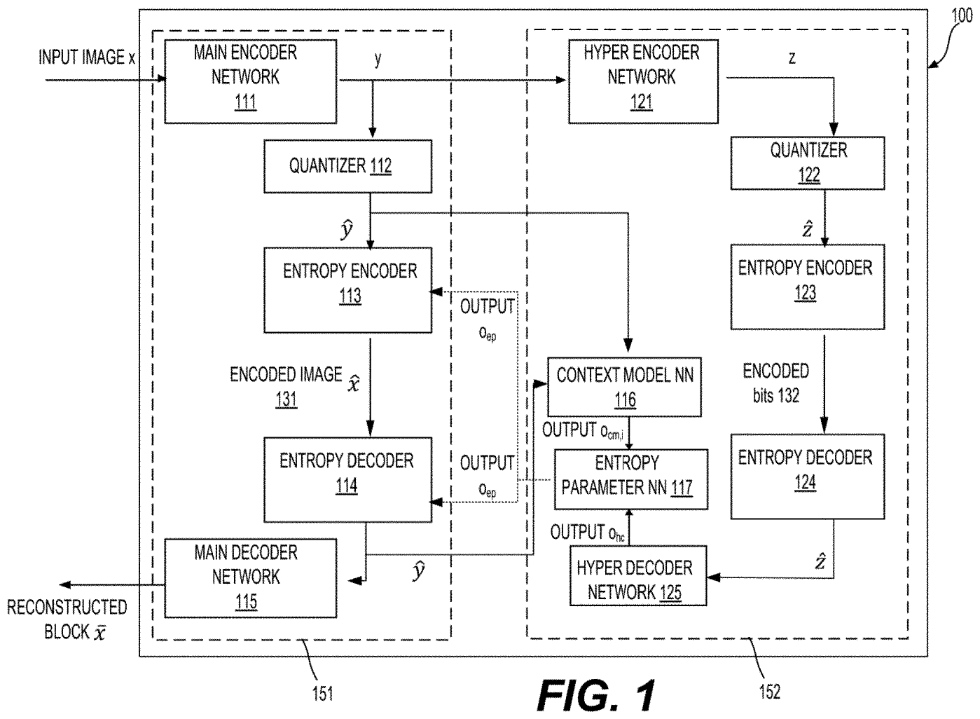

FIG. 1 shows an NIC framework (100) (e.g., a NIC system) in some examples. The NIC framework (100) can be based on neural networks, such as DNNs and/or CNNs. The NIC framework (100) can be used to compress (e.g., encode) images and decompress (e.g., decode or reconstruct) compressed images (e.g., encoded images).

Specifically, in the FIG. 1 example, the compression model in the NIC framework (100) includes two levels that are referred to as a main level of the compression model and a hyper level of the compression model. The main level of the compression model and the hyper level of the compression model can be implemented using neural networks. The neural networks for the main level of the compression model is shown as a first sub-NN (151) and the hyper level of the compression model is shown as a second sub-NN (152) in FIG. 1.

The first sub-NN (151) can resemble an autoencoder and can be trained to generate a compressed image \hat{x} of an input image x and decompress the compressed image (i.e., the encoded image) \hat{x} to obtain a reconstructed image x̅. The first sub-NN (151) can include a plurality of components (or modules), such as a main encoder neural network (or a main encoder network) (111), a quantizer (112), an entropy encoder (113), an entropy decoder (114), and a main decoder neural network (or a main encoder network) (115).

Referring to FIG. 1, the main encoder network (111) can generate a latent or a latent representation y from the input image x (e.g., an image to be compressed or encoded). In an example, the main encoder network (111) is implemented using a CNN. A relationship between the latent representation y and the input image x can be described using Eq. 2:

y=f₁(x; θ₁) Eq. 2

where a parameter θ₁ represents parameters, such as weights used in convolution kernels in the main encoder network (111) and biases (if biases are used in the main encoder network (111)).

The latent representation y can be quantized using the quantizer (112) to generate a quantized latent ŷ. The quantized latent ŷ can be compressed, for example, using lossless compression by the entropy encoder (113) to generate the compressed image (e.g., an encoded image) \hat{x} (131) that is a compressed representation \hat{x} of the input image x. The entropy encoder (113) can use entropy coding techniques such as Huffman coding, arithmetic coding, or the like. In an example, the entropy encoder (113) uses arithmetic encoding and is an arithmetic encoder. In an example, the encoded image (131) is transmitted in a coded bitstream.

The encoded image (131) can be decompressed (e.g., entropy decoded) by the entropy decoder (114) to generate an output. The entropy decoder (114) can use entropy coding techniques such as Huffman coding, arithmetic coding, or the like that correspond to the entropy encoding techniques used in the entropy encoder (113). In an example, the entropy decoder (114) uses arithmetic decoding and is an arithmetic decoder. In an example, lossless compression is used in the entropy encoder (113), lossless decompression is used in the entropy decoder (114), and noises, such as due to the transmission of the encoded image (131) are omissible, the output from the entropy decoder (114) is the quantized latent ŷ.

The main decoder network (115) can decode the quantized latent ŷ to generate the reconstructed image x̅. In an example, the main decoder network (115) is implemented using a CNN. A relationship between the reconstructed image x̅ (i.e., the output of the main decoder network (115)) and the quantized latent ŷ (i.e., the input of the main decoder network (115)) can be described using Eq. 3:

x̅=f₂(ŷ; θ₂) Eq. 3

where a parameter θ₂ represents parameters, such as weights used in convolution kernels in the main decoder network (115) and biases (if biases are used in the main decoder network (115)). Thus, the first sub-NN (151) can compress (e.g., encode) the input image x to obtain the encoded image (131) and decompress (e.g., decode) the encoded image (131) to obtain the reconstructed image x̅. The reconstructed image x̅ can be different from the input image x due to quantization loss introduced by the quantizer (112).

In some examples, the second sub-NN (152) can learn the entropy model (e.g., a prior probabilistic model) over the quantized latent ŷ used for entropy coding. Thus, the entropy model can be a conditioned entropy model, e.g., a Gaussian mixture model (GMM), a Gaussian scale model (GSM) that is dependent on the input image x.

In some examples, the second sub-NN (152) can include a context model NN (116), an entropy parameter NN (117), a hyper encoder network (121), a quantizer (122), an entropy encoder (123), an entropy decoder (124), and a hyper decoder network (125). The entropy model used in the context model NN (116) can be an autoregressive model over latent (e.g., the quantized latent ŷ). In an example, the hyper encoder network (121), the quantizer (122), the entropy encoder (123), the entropy decoder (124), and the hyper decoder network (125) form a hyperprior model that can be implemented using neural networks in the hyper level (e.g., a hyperprior NN). The hyperprior model can represent information useful for correcting context-based predictions. Data from the context model NN (116) and the hyperprior model can be combined by the entropy parameter NN (117). The entropy parameter NN (117) can generate parameters, such as mean and scale parameters for the entropy model such as a conditional Gaussian entropy model (e.g., the GMM).

Referring to FIG. 1, at an encoder side, the quantized latent ŷ from the quantizer (112) is fed into the context model NN (116). At a decoder side, the quantized latent ŷ from the entropy decoder (114) is fed into the context model NN (116). The context model NN (116) can be implemented using a neural network, such as a CNN. The context model NN (116) can generate an output o_{cm,i} based on a context ŷ_{<i} that is the quantized latent ŷ available to the context model NN (116). The context ŷ_{<i} can include previously quantized latent at the encoder side or previously entropy decoded quantized latent at the decoder side. A relationship between the output o_{cm,i} and the input (e.g., ŷ_{<i}) of the context model NN (116) can be described using Eq. 4:

o_{cm,i}=f₃(ŷ_{<i}; θ₃) Eq. 4

where a parameter θ₃ represents parameters, such as weights used in convolution kernels in the context model NN (116) and biases (if biases are used in the context model NN (116)).

The output o_{cm,i} from the context model NN (116) and an output o_{hc} from the hyper decoder network (125) are fed into the entropy parameter NN (117) to generate an output oₑₚ. The entropy parameter NN (117) can be implemented using a neural network, such as a CNN. A relationship between the output oₑₚ and the inputs (e.g., o_{cm,i} and o_{hc}) of the entropy parameter NN (117) can be described using Eq. 5:

oₑₚ=f₄(o_{cm,i}, o_{hc}; θ₄) Eq. 5

where a parameter θ₄ represents parameters, such as weights used in convolution kernels in the entropy parameter NN (117) and biases (if biases are used in the entropy parameter NN (117)). The output oₑₚ of the entropy parameter NN (117) can be used in determining (e.g., conditioning) the entropy model, and thus the conditioned entropy model can be dependent on the input image x, for example, via the output o_{hc} from the hyper decoder network (125). In an example, the output oₑₚ includes parameters, such as the mean and scale parameters, used to condition the entropy model (e.g., GMM). Referring to FIG. 1, the entropy model (e.g., the conditioned entropy model) can be employed by the entropy encoder (113) and the entropy decoder (114) in entropy coding and entropy decoding, respectively.

The second sub-NN (152) can be described below. The latent y can be fed into the hyper encoder network (121) to generate a hyper latent z. In an example, the hyper encoder network (121) is implemented using a neural network, such as a CNN. A relationship between the hyper latent z and the latent y can be described using Eq. 6.

z=f₅(y; θ₅) Eq. 6

where a parameter θ₅ represents parameters, such as weights used in convolution kernels in the hyper encoder network (121) and biases (if biases are used in the hyper encoder network (121)).

The hyper latent z is quantized by the quantizer (122) to generate a quantized latent \hat{z}. The quantized latent \hat{z} can be compressed, for example, using lossless compression by the entropy encoder (123) to generate side information, such as encoded bits (132) from the hyper neural network. The entropy encoder (123) can use entropy coding techniques such as Huffman coding, arithmetic coding, or the like. In an example, the entropy encoder (123) uses arithmetic encoding and is an arithmetic encoder. In an example, the side information, such as the encoded bits (132), can be transmitted in the coded bitstream, for example, together with the encoded image (131).

The side information, such as the encoded bits (132), can be decompressed (e.g., entropy decoded) by the entropy decoder (124) to generate an output. The entropy decoder (124) can use entropy coding techniques such as Huffman coding, arithmetic coding, or the like. In an example, the entropy decoder (124) uses arithmetic decoding and is an arithmetic decoder. In an example, lossless compression is used in the entropy encoder (123), lossless decompression is used in the entropy decoder (124), and noises, such as due to the transmission of the side information are omissible, the output from the entropy decoder (124) can be the quantized latent \hat{z}. The hyper decoder network (125) can decode the quantized latent \hat{z} to generate the output o_{hc}. A relationship between the output o_{hc} and the quantized latent \hat{z} can be described using Eq. 7.

o_{hc}=f₆(\hat{z}; θ₆) Eq. 7

where a parameter θ₆ represents parameters, such as weights used in convolution kernels in the hyper decoder network (125) and biases (if biases are used in the hyper decoder network (125)).

As described above, the compressed or encoded bits (132) can be added to the coded bitstream as the side information, which enables the entropy decoder (114) to use the conditional entropy model. Thus, the entropy model can be image-dependent and spatially adaptive, and thus can be more accurate than a fixed entropy model.

The NIC framework (100) can be suitably adapted, for example, to omit one or more components shown in FIG. 1, to modify one or more components shown in FIG. 1, and/or to include one or more components not shown in FIG. 1. In an example, a NIC framework using a fixed entropy model includes the first sub-NN (151), and does not include the second sub-NN (152). In an example, a NIC framework includes the components in the NIC framework (100) except the entropy encoder (123) and the entropy decoder (124).

In an embodiment, one or more components in the NIC framework (100) shown in FIG. 1 are implemented using neural network(s), such as CNN(s). Each NN-based component (e.g., the main encoder network (111), the main decoder network (115), the context model NN (116), the entropy parameter NN (117), the hyper encoder network (121), or the hyper decoder network (125)) in a NIC framework (e.g., the NIC framework (100)) can include any suitable architecture (e.g., have any suitable combinations of layers), include any suitable types of parameters (e.g., weights, biases, a combination of weights and biases, and/or the like), and include any suitable number of parameters.

In an embodiment, the main encoder network (111), the main decoder network (115), the context model NN (116), the entropy parameter NN (117), the hyper encoder network (121), and the hyper decoder network (125) are implemented using respective CNNs.

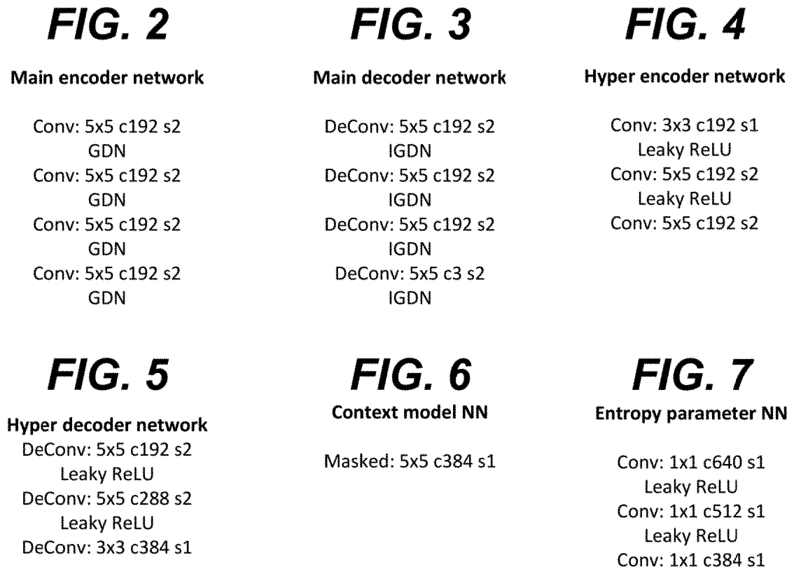

FIG. 2 shows an exemplary CNN for the main encoder network (111) according to an embodiment of the disclosure. For example, the main encoder network (111) includes four sets of layers where each set of layers includes a convolution layer 5×5 c192 s2 followed by a GDN layer. One or more layers shown in FIG. 2 can be modified and/or omitted. Additional layer(s) can be added to the main encoder network (111).

FIG. 3 shows an exemplary CNN for the main decoder network (115) according to an embodiment of the disclosure. For example, the main decoder network (115) includes three sets of layers where each set of layers includes a deconvolution layer 5×5 c192 s2 followed by an IGDN layer. In addition, the three sets of layers are followed by a deconvolution layer 5×5 c3 s2 followed by an IGDN layer. One or more layers shown in FIG. 3 can be modified and/or omitted. Additional layer(s) can be added to the main decoder network (115).

FIG. 4 shows an exemplary CNN for the hyper encoder network (121) according to an embodiment of the disclosure. For example, the hyper encoder network (121) includes a convolution layer 3×3 c192 s1 followed by a leaky ReLU, a convolution layer 5×5 c192 s2 followed by a leaky ReLU, and a convolution layer 5×5 c192 s2. One or more layers shown in FIG. 4 can be modified and/or omitted. Additional layer(s) can be added to the hyper encoder network (121).

FIG. 5 shows an exemplary CNN for the hyper decoder network (125) according to an embodiment of the disclosure. For example, the hyper decoder network (125) includes a deconvolution layer 5×5 c192 s2 followed by a leaky ReLU, a deconvolution layer 5×5 c288 s2 followed by a leaky ReLU, and a deconvolution layer 3×3 c384 s1. One or more layers shown in FIG. 5 can be modified and/or omitted. Additional layer(s) can be added to the hyper decoder network (125).

FIG. 6 shows an exemplary CNN for the context model NN (116) according to an embodiment of the disclosure. For example, the context model NN (116) includes a masked convolution 5×5 c384 s1 for context prediction, and thus the context ŷ_{<i} in Eq. 4 includes a limited context (e.g., a 5×5 convolution kernel). The convolution layer in FIG. 6 can be modified. Additional layer(s) can be added to the context model NN (1016).

FIG. 7 shows an exemplary CNN for the entropy parameter NN (117) according to an embodiment of the disclosure. For example, the entropy parameter NN (117) includes a convolution layer 1×1 c640 s1 followed by a leaky ReLU, a convolution layer 1×1 c512 s1 followed by leaky ReLU, and a convolution layer 1×1 c384 s1. One or more layers shown in FIG. 7 can be modified and/or omitted. Additional layer(s) can be added to the entropy parameter NN (117).

The NIC framework (100) can be implemented using CNNs, as described with reference to FIGS. 2-7. The NIC framework (100) can be suitably adapted such that one or more components (e.g., (111), (115), (116), (117), (121), and/or (125)) in the NIC framework (100) are implemented using any suitable types of neural networks (e.g., CNNs or non-CNN based neural networks). One or more other components the NIC framework (100) can be implemented using neural network(s).

The NIC framework (100) that includes neural networks (e.g., CNNs) can be trained to learn the parameters used in the neural networks. For example, when CNNs are used, the parameters represented by θ₁-θ₆, such as the weights used in the convolution kernels in the main encoder network (111) and biases (if biases are used in the main encoder network (111)), the weights used in the convolution kernels in the main decoder network (115) and biases (if biases are used in the main decoder network (115)), the weights used in the convolution kernels in the hyper encoder network (121) and biases (if biases are used in the hyper encoder network (121)), the weights used in the convolution kernels in the hyper decoder network (125) and biases (if biases are used in the hyper decoder network (125)), the weights used in the convolution kernel(s) in the context model NN (116) and biases (if biases are used in the context model NN (116)), and the weights used in the convolution kernels in the entropy parameter NN (117) and biases (if biases are used in the entropy parameter NN (117)), respectively, can be learned in the training process (e.g. offline training process, online training process, and the like).

In an example, referring to FIG. 2, the main encoder network (111) includes four convolution layers where each convolution layer has a convolution kernel of 5×5 and 192 channels. Thus, a number of the weights used in the convolution kernels in the main encoder network (111) is 19200 (i.e., 4×5×5×192). The parameters used in the main encoder network (111) include the 19200 weights and optional biases. Additional parameter(s) can be included when biases and/or additional NN(s) are used in the main encoder network (111).

Referring to FIG. 1, the NIC framework (100) includes at least one component or module built on neural network(s). The at least one component can include one or more of the main encoder network (111), the main decoder network (115), the hyper encoder network (121), the hyper decoder network (125), the context model NN (116), and the entropy parameter NN (117). The at least one component can be trained individually. In an example, the training process is used to learn the parameters for each component separately. The at least one component can be trained jointly as a group. In an example, the training process is used to learn the parameters for a subset of the at least one component jointly. In an example, the training process is used to learn the parameters for all of the at least one component, and thus is referred to as an E2E optimization.

In the training process for one or more components in the NIC framework (100), the weights (or the weight coefficients) of the one or more components can be initialized. In an example, the weights are initialized based on pre-trained corresponding neural network model(s) (e.g., DNN models, CNN models). In an example, the weights are initialized by setting the weights to random numbers.

A set of training images can be employed to train the one or more components, for example, after the weights are initialized. The set of training images can include any suitable images having any suitable size(s). In some examples, the set of training images includes images from raw images, natural images, computer-generated images, and/or the like that are in the spatial domain. In some examples, the set of training images includes images from residue images or residue images having residue data in the spatial domain. The residue data can be calculated by a residue calculator. In some examples, raw images and/or residue images including residue data can be used directly to train neural networks in a NIC framework, such as the NIC framework (100). Thus, raw images, residue images, images from raw images, and/or images from residue images can be used to train neural networks in a NIC framework.

For purposes of brevity, the training process (e.g., offline training process, online training process, and the like) below is described using a training image as an example. The description can be suitably adapted to a training block. A training image t of the set of training images can be passed through the encoding process in FIG. 1 to generate a compressed representation (e.g., encoded information, for example, to a bitstream). The encoded information can be passed through the decoding process described in FIG. 1 to compute and reconstruct a reconstructed image t̅.

For the NIC framework (100), two competing targets, e.g., a reconstruction quality and a bit consumption are balanced. A quality loss function (e.g., a distortion or distortion loss) D (t, t̅) can be used to indicate the reconstruction quality, such as a difference between the reconstruction (e.g., the reconstructed image t̅) and an original image (e.g., the training image t). A rate (or a rate loss) R can be used to indicate the bit consumption of the compressed representation. In an example, the rate loss R further includes the side information, for example, used in determining a context model.

For neural image compression, differentiable approximations of quantization can be used in E2E optimization. In various examples, in the training process of neural network-based image compression, noise injection is used to simulate quantization, and thus quantization is simulated by the noise injection instead of being performed by a quantizer (e.g., the quantizer (112)). Thus, training with noise injection can approximate the quantization error variationally. A bits per pixel (BPP) estimator can be used to simulate an entropy coder, and thus entropy coding is simulated by the BPP estimator instead of being performed by an entropy encoder (e.g., (113)) and an entropy decoder (e.g., (114)). Therefore, the rate loss R in the loss function L shown in Eq. 1 during the training process can be estimated, for example, based on the noise injection and the BPP estimator. In general, a higher rate R can allow for a lower distortion D, and a lower rate R can lead to a higher distortion D. Thus, a trade-off hyperparameter λ in Eq. 1 can be used to optimize a joint R-D loss L where L as a summation of λD and R can be optimized. The training process can be used to adjust the parameters of the one or more components (e.g., (111) (115)) in the NIC framework (100) such that the joint R-D loss L is minimized or optimized. In some examples, a trade-off hyperparameter λ can be used to optimize the joint Rate-Distortion (R-D) loss as:

L(x, x̅, \hat{r}₁, . . . , \hat{r}_{N}, ŷ)=λD(x, x̅)+R(Σ_{q}ⁿsᵢ, σ₁ⁿuᵢ)+βE Eq. 8

where E measures the distortion of the decoded image residuals compared with the original image residuals before encoding, which acts as regularization loss for the residual encoding/decoding DNNs and the encoding/decoding DNNs. β is a hyperparameter to balance the importance of the regularization loss.

Various models can be used to determine the distortion loss D and the rate loss R, and thus to determine the joint R-D loss L in Eq. 1. In an example, the distortion loss D(t, t̅) is expressed as a peak signal-to-noise ratio (PSNR) that is a metric based on mean squared error, a multiscale structural similarity (MS-SSIM) quality index, a weighted combination of the PSNR and MS-SSIM, or the like.

In an example, the target of the training process is to train the encoding neural network (e.g., the encoding DNN), such as a video encoder to be used on an encoder side and the decoding neural network (e.g., the decoding DNN), such as a video decoder to be used on a decoder side. In an example, referring to FIG. 1, the encoding neural network can include the main encoder network (111), the hyper encoder network (121), the hyper decoder network (125), the context model NN (116), and the entropy parameter NN (117). The decoding neural network can include the main decoder network (115), the hyper decoder network (125), the context model NN (116), and the entropy parameter NN (117). The video encoder and/or the video decoder can include other component(s) that are based on NN(s) and/or not based on NN(s).

The NIC framework (e.g., the NIC framework (100)) can be trained in an E2E fashion. In an example, the encoding neural network and the decoding neural network are updated jointly in the training process based on backpropagated gradients in an E2E fashion, for example using a gradient descent algorithm. The gradient descent algorithm can iteratively optimizing parameters of the NIC framework for finding a local minimum of a differentiable function (e.g.., a local minimum of a rate distortion loss) of the NIC framework. For example, the gradient descent algorithm can take repeated steps in the opposite direction of the gradient (or approximate gradient) of the differentiable function at the current point.

After the parameters of the neural networks in the NIC framework (100) are trained, one or more components in the NIC framework (100) can be used to encode and/or decode images. In an embodiment, on the encoder side, an image encoder is configured to encode the input image x into the encoded image (131) to be transmitted in a bitstream. The image encoder can include multiple components in the NIC framework (100). In an embodiment, on the decoder side, a corresponding image decoder is configured to decode the encoded image (131) carried in the bitstream into the reconstructed image x̅. The image decoder can include multiple components in the NIC framework (100).

It is noted that an image encoder and an image decoder according to an NIC framework can have corresponding structures.

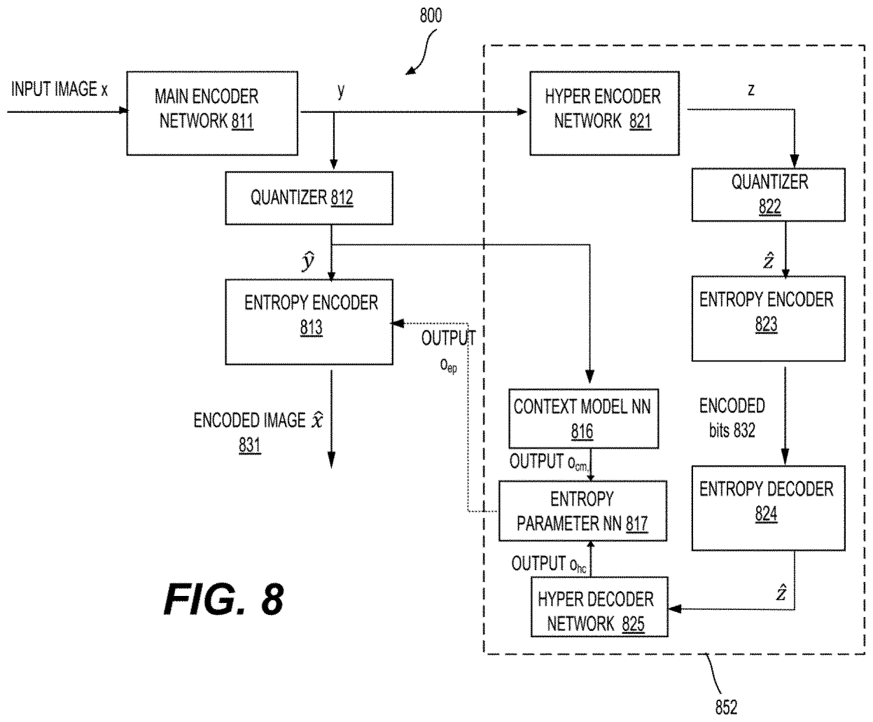

FIG. 8 shows an exemplary image encoder (800) according to an embodiment of the disclosure. The image encoder (800) includes a main encoder network (811), a quantizer (812), an entropy encoder (813), and a second sub-NN (852). The main encoder network (811) is similarly configured as the main encoder network (111), the quantizer (812) is similarly configured as the quantizer (112), the entropy encoder (813) is similarly configured as the entropy encoder (113), and the second sub-NN (852) is similarly configured as the second sub-NN (152). The description has been provided above with reference to FIG. 1 and will be omitted herein for clarity.

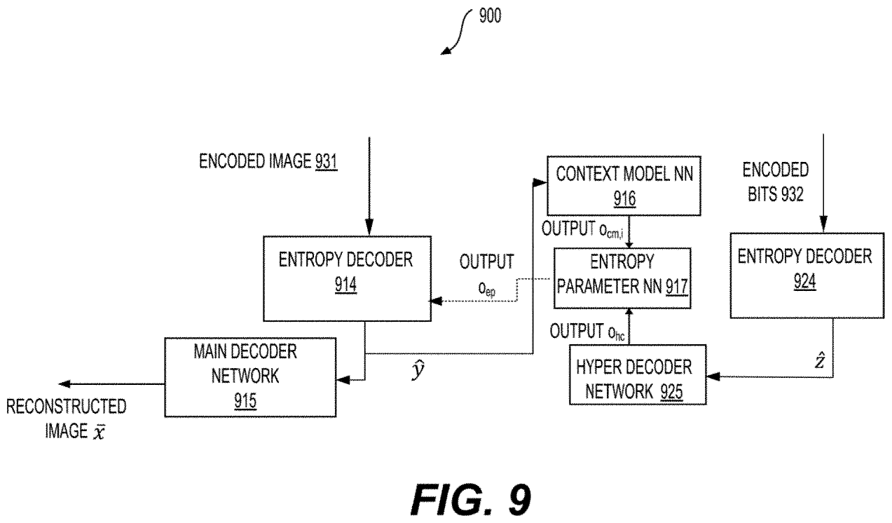

FIG. 9 shows an exemplary image decoder (900) according to an embodiment of the disclosure. The image decoder (900) can correspond to the image encoder (800). The image decoder (900) can include a main decoder network (915), an entropy decoder (914), a context model NN (916), an entropy parameter NN (917), an entropy decoder (924), and a hyper decoder network (925). The main decoder network (915) is similarly configured as the main decoder network (115), the entropy decoder (914) is similarly configured as the entropy decoder (114), the context model NN (916) is similarly configured as the context model NN (116), the entropy parameter NN (917) is similarly configured as the entropy parameter NN (117), the entropy decoder (924) is similarly configured as the entropy decoder (124), and the hyper decoder network (925) is similarly configured as the hyper decoder network (125). The description has been provided above with reference to FIG. 1 and will be omitted herein for clarity.

Referring to FIGS. 8-9, on the encoder side, the image encoder (800) can generate an encoded image (831) and encoded bits (832) to be transmitted in the bitstream. On the decoder side, the image decoder (900) can receive and decode an encoded image (931) and encoded bits (932). The encoded image (931) and the encoded bits (932) can be parsed from a received bitstream.

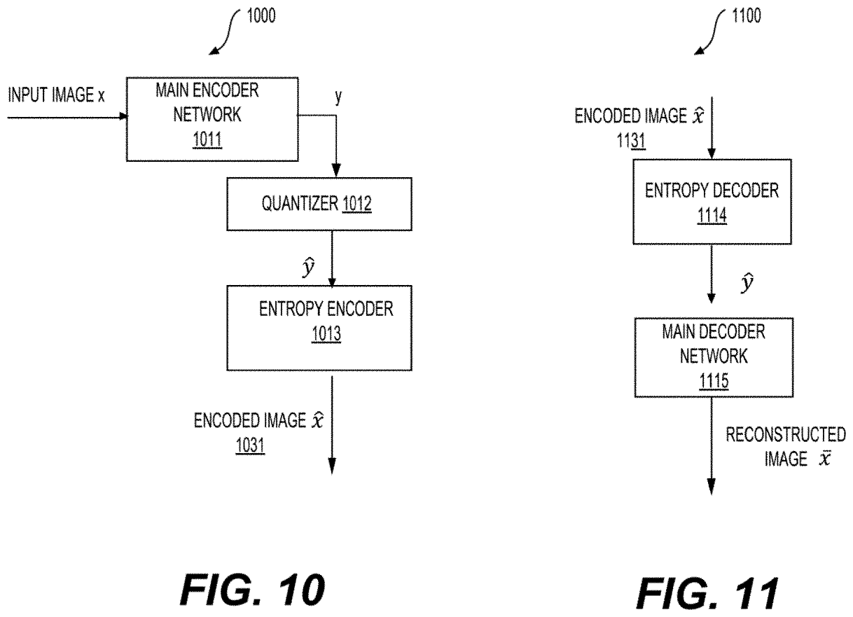

FIGS. 10-11 show an exemplary image encoder (1000) and a corresponding image decoder (1100), respectively, according to embodiments of the disclosure. Referring to FIG. 10, the image encoder (1000) includes the main encoder network (1011), the quantizer (1012), and the entropy encoder (1013). The main encoder network (1011) is similarly configured as the main encoder network (111), the quantizer (1012) is similarly configured as the quantizer (112), and the entropy encoder (1013) is similarly configured as the entropy encoder (113). The description has been provided above with reference to FIG. 1 and will be omitted herein for clarity.

Referring to FIG. 11, the image decoder (1100) includes a main decoder network (1115) and an entropy decoder (1114). The main decoder network (1115) is similarly configured as the main decoder network (115) and the entropy decoder (1114) is similarly configured as the entropy decoder (114). The description has been provided above with reference to FIG. 1 and will be omitted herein for clarity.

Referring to FIGS. 10 and 11, the image encoder (1000) can generate the encoded image (1031) to be included in the bitstream. The image decoder (1100) can receive a bitstream and decode the encoded image (1131) carried in the bitstream.

According to an aspect of the disclosure, in NN-based image compression methods, such as DNN-based or CNN-based image compression methods, instead of directly encoding an entire image, a block-based or block-wise coding mechanism can be effective for compressing images. An entire image can be partitioned into blocks of a same or different sizes, and the blocks can be compressed individually. In an embodiment, an image may be split into blocks with an equal size or non-equal sizes. The spilt blocks instead of the image can be compressed.

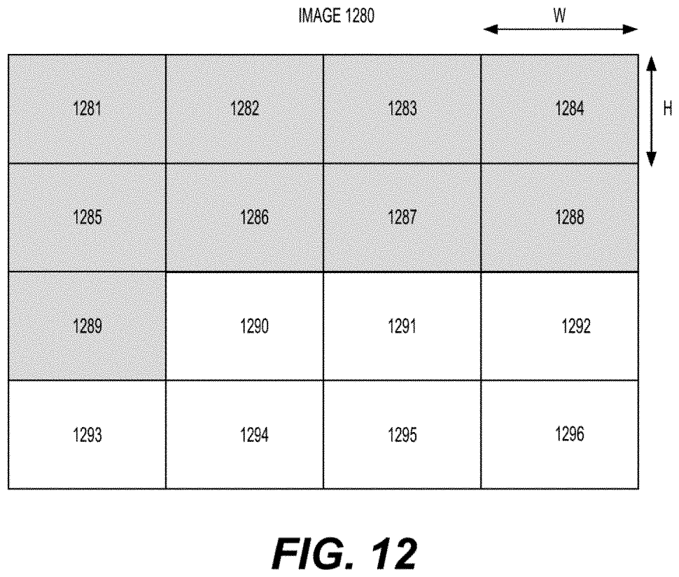

FIG. 12 shows an example of a block-wise image coding. An image (1280) can be partitioned into blocks, e.g., blocks (1281)-(1296). The blocks (1281)-(1296) can be compressed, for example, according to a scanning order. In an example shown in FIG. 12, the blocks (1281)-(1289) are already compressed, and the blocks (1290)-(1296) are to be compressed.

In an embodiment, an image is treated as a block where the block is the entire image, and the image is compressed without being split into blocks. The entire image can be the input of an E2E NIC framework.

Further, some aspects of the disclosure provide techniques for online training based image compression with neural network, such as artificial intelligence (AI) based neural image compression (NIC). In some examples, the techniques for online training based image compression can be applied on a compression model of an end-to-end (E2E) optimized framework. The E2E optimized framework includes an encoding portion and a decoding portion. The encoding portion and the decoding portion may have an overlapping portion (e.g., identical neural networks, identical neural network layers). In some examples, the encoding portion includes one or more pretrained neural networks (referred to as one or more first pretrained neural networks) that can encode one or more images into a bitstream. The decoding portion includes one or more pretrained neural networks (referred to as one or more second pretrained neural networks) that can decode the bitstream to generate one or more reconstructed images. In some examples, a specific pretrained neural network in the one or more first pretrained neural networks also exists in the one or more second pretrained neural networks. According to some aspects of the disclosure, during the online training process, the decoding portion is fixed, and modules that only in the encoding portion can be tuned based on one or more input images to optimize a rate-distortion performance. For example, parameters that are only in the encoding portion (not in the decoding portion) of the E2E optimized framework can be tuned based on the one or more input images to determine updated parameters that can optimize a rate-distortion performance. The encoding portion with the updated parameters (also referred to as optimized encoder) can then encode the one or more input images to generate a bitstream. The updated parameters are encoder only parameters and are not need to be provided to the decoder side, thus coding efficiency can be improved.

According to an aspect of the disclosure, for each input image (also referred to as target image) to be compressed, an online training process is applied to find an optimized encoder for the target image and then the target image is compressed by the optimized encoder instead of the original encoder. By using the optimized encoder, the NIC can achieve better compression performance. In some examples, the online training based encoder tuning is used as a preprocessing step (e.g., before an official compression of each input image) for boosting the compression performance of a E2E NIC compression. In an example, the online training based encoder tuning can be performed on a pretrained compression model, such as a pretrained NIC framework. According to an aspect of the disclosure, the pretrained compression model itself, such as the structure of the pretrained NIC framework does not require any training or fine-tuning. The online training based encoder tuning requires no additional training data other than the target image.

As described above, learning (training) based image compression can be viewed as a two-step mapping process that includes a first step of encoding mapping and a second step of decoding mapping. In the first step, an original image x₀ (e.g.., target image) in a high dimensional space (e.g., two dimensional image, three dimensional image, two dimensional image with three color channels, and the like) is mapped to a bit-stream with length R(x₀). In the second step, the bitstream is then mapped back to the original high dimensional space as a reconstructed image [symbol] . For example, a pretrained NIC framework can map the original image x₀ to a first reconstructed image [symbol] .

According to an aspect of the disclosure, when an optimized encoder exists, such that the optimized NIC framework (with the optimized encoder) can map the original image x₀ to a second reconstructed image [symbol] that is closer to the original image x₀ (than the first reconstructed image [symbol] ) according to a distance measurement or loss function (e.g., with a smaller loss function), better compression can be achieved. Best compression performance can be achieved at the global minimum of Eq. 1.

According to some aspects of the disclosure, the online training based encoder tuning may be performed in any suitable middle steps of a neural network at the encoder side, to reduce the differences between the decoded image and the original image.

According to an aspect of the disclosure, in the offline training process (that is also referred to as model training phase), the gradient descent algorithm is used for determining parameters of the entire compression model. In some examples, in the online training based encoder tuning process, the decoder portion of the compression model is fixed, and the gradient descent algorithm is used to update the encoder portion of the compression model. It is noted that the entire compression model can be made differentiable (so that the gradients can be backpropagated) by replacing the non-differentiable parts with differentiable ones (e.g., replacing quantization with noise injection), thus the gradient descent algorithm can be used in the online training based encoder tuning process to iteratively optimize the encoder portion.

It is noted that, the online training based encoder tuning process can use a first hyperparameter—step size and a second hyper parameter—number of steps. The step size indicates a ‘learning rate’ of the online training based encoder tuning process. In some embodiments, different step sizes are used during the online training based encoder tuning process for images with different types of contents to achieve the best optimization results. The number of steps indicates the number of updates in the online training based encoder tuning process. The hyperparameters are used in the online training based encoder tuning process with a loss function. In an example, the step size is used in a gradient descent algorithm or a backpropagation calculation performed in the online training based encoder tuning process, and the number of iterations can be used as a threshold of a maximum number of iterations to control a termination of the learning process.

According to some aspects of the disclosure, for each input image x₀, three operations, such as a first operation of online training based encoder tuning operation, a second operation of encoding, and a third operation of decoding can be performed according to an NIC framework. In some examples, the first operation and the second operation are performed in an electronic device according to the NIC framework and the third operation can be performed by the same electronic device or a different electronic device according to the NIC framework.

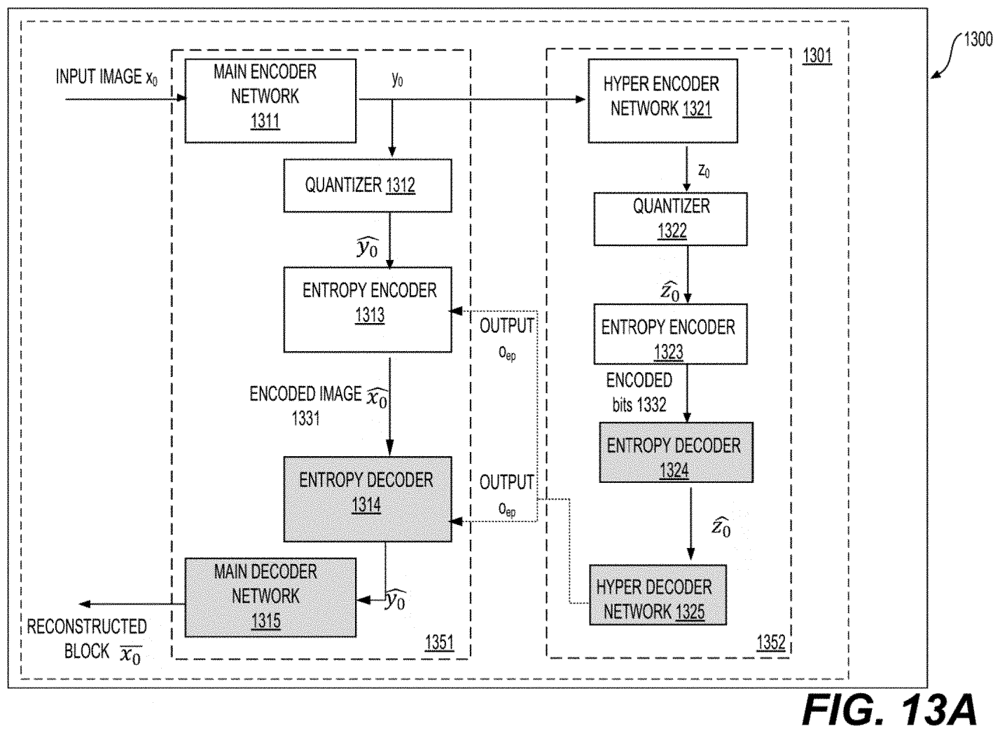

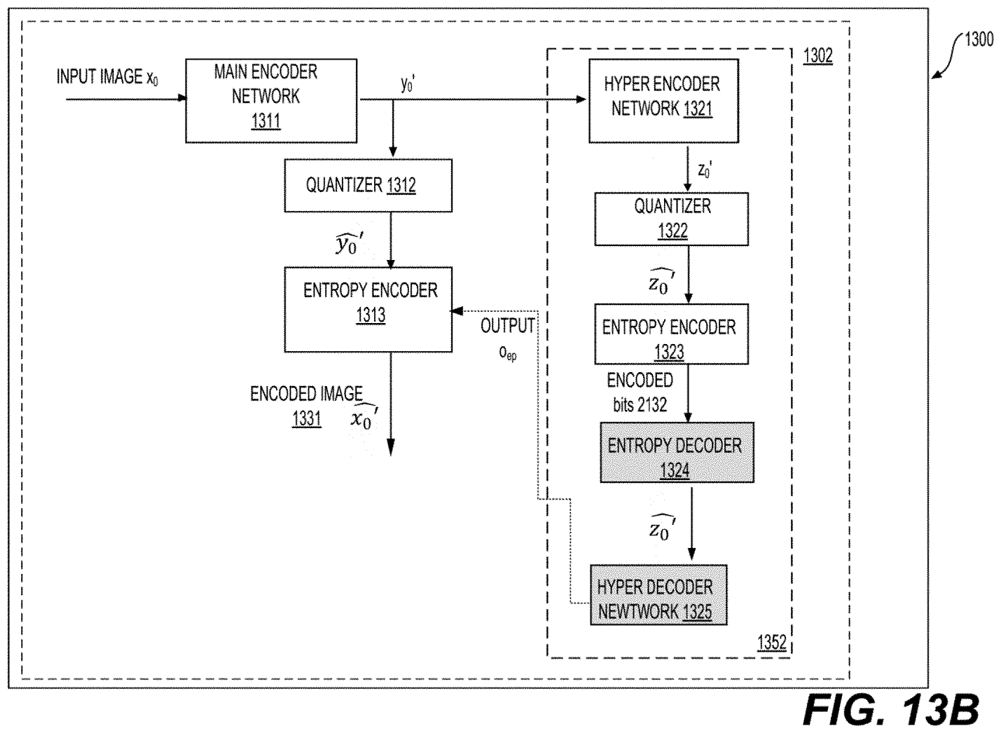

FIGS. 13A and 13B show an electronic device (1300) that are configured to perform the online training based encoder tuning operation and the encoding operation for an input image x₀ according to some aspects of the disclosure. The electronic device (2100) can be any suitable device, such as a server computer, a desktop computer, a laptop computer, and the like.

FIG. 13A shows a diagram of components in the electronic device (1300) to perform the online training based encoder tuning operation. The electronic device (1300) includes components forming an NIC framework (1301) (also referred to as a compression model) that includes two levels, such as a main level of the compression model shown as a first sub-NN (1351) and a hyper level of the compression model shown as a second sub-NN (1352). The first sub-NN (1351) is similarly configured as the first sub-NN (151), and the second sub-NN (1352) is similarly configured as the second sub-NN (152) in FIG. 1. It is noted that the NIC framework in FIG. 13A is an example to illustrate the techniques for online training based encoder tuning, and the techniques can be used in other suitable NIC framework, such as the NIC framework in FIG. 1, the NIC framework in FIGS. 10-11, and the like.

The first sub-NN (1351) includes a main encoder network (1311), a quantizer (1312), an entropy encoder (1313), an entropy decoder (1314), and a main decoder network (1315). The main encoder network (1311) is similarly configured as the main encoder network (111), the quantizer (1312) is similarly configured as the quantizer (112), the entropy encoder (1313) is similarly configured as the entropy encoder (113), and the entropy decoder (1314) is similarly configured as the entropy decoder (114), and the main decoder network (1315) is similarly configured as the main decoder network (115). The description has been provided above with reference to FIG. 1 and will be omitted herein for clarity.

The second sub-NN (1352) can include a hyper encoder network (1321), a quantizer (1322), an entropy encoder (1323), an entropy decoder (1324), and a hyper decoder network (1325). The hyper encoder network (1321) is similarly configured as the hyper encoder network (121), the quantizer (1322) is similarly configured as the quantizer (122), the entropy encoder (1323) is similarly configured as the entropy encoder (123), the entropy decoder (1324) is similarly configured as the entropy decoder (124), and the hyper decoder network (1325) is similarly configured as the hyper decoder network (125). The description has been provided above with reference to FIG. 1 and will be omitted herein for clarity.

In some examples, initially, parameters in the neural networks of the NIC framework (1301) are pretrained parameters. During the online training based encoder tuning operation, in some examples, for an input image x₀, the main encoder network (1311) generates a latent representation y₀ from the input image x₀. The latent representation y₀ can be quantized using the quantizer (1312) to generate a quantized latent [symbol] . The quantized latent [symbol] can be compressed, for example, using lossless compression by the entropy encoder (1313) to generate the compressed image (e.g., an encoded image) [symbol] (1331) that is a compressed representation [symbol] the input image x₀.

The encoded image (1331) can be decompressed (e.g., entropy decoded) by the entropy decoder (1314) to generate the quantized latent [symbol] . The main decoder network (1315) can decode the quantized latent [symbol] to generate the reconstructed image x̅₀̅. The reconstructed image x̅₀̅ can be different from the input image x₀ due to quantization loss introduced by the quantizer (1312).

The latent representation y₀ can be fed into the hyper encoder network (1321) to generate a hyper latent z₀. The hyper latent z₀ is quantized by the quantizer (1322) to generate a quantized latent [symbol] . The quantized latent [symbol] can be compressed, for example, using lossless compression by the entropy encoder (1323) to generate side information, such as encoded bits (1332).

The side information, such as the encoded bits (1332), can be decompressed (e.g., entropy decoded) by the entropy decoder (1324) to generate the quantized latent [symbol] . The hyper decoder network (1325) can decode the quantized latent [symbol] to generate the output oₑₚ. The output oₑₚ can be provided to the entropy encoder (1313) and the entropy decoder (1314) to determine entropy model.

In some examples, a performance metric, such as a rate distortion loss can be calculated, for example according to Eq. 1. Further, the encoder only parameters in the NIC framework can be trained. In an example, the encoder only parameters are updated in the training process (online training based encoder tuning process) based on backpropagated gradients in an end to end manner, for example using a gradient descent algorithm. The gradient descent algorithm can iteratively optimize the encoder only parameters for finding a local minimum of a differentiable function (e.g.., a local minimum of a rate distortion loss). For example, the gradient descent algorithm can take repeated steps in the opposite direction of the gradient (or approximate gradient) of the differentiable function at the current point.

In some examples, a corresponding decoder can have entropy decoders corresponding to the entropy decoder (1314) and the entropy decoder (1324), a main decoder network corresponding to the main decoder network (1315), and a hyper decoder network corresponding to the hyper decoder network (1325). Thus, the encoder only portion includes the main encoder network (1311), the quantizer (1312), the entropy encoder (1313), the hyper encoder network (1321), the quantizer (1322), and the entropy encoder (1323).

In some examples, parameters in the neural networks of the main encoder network (1311) and the hyper encoder network (1321) are tuned during the online training based encoder tuning operation to determine updated parameters to achieve a minimum of the rate distortion loss for the input image x₀.

FIG. 13B shows a diagram of a neural network based image encoder (1302) in the electronic device (1300) to perform the encoding operation for the input image x₀ according to some aspects of the disclosure. The neural network based image encoder (1302) is formed according to the NIC framework (1301) with updated parameters from the online training based encoder tuning operation. The neural network based image encoder (1302) includes the main encoder network (1311), the quantizer (1312), the entropy encoder (1313), the hyper encoder network (1321), the quantizer (1322), the entropy encoder (1323), the entropy decoder (1324), and the hyper decoder network (1325). In some examples, one or more parameters of the main encoder network (1311) and/or the hyper encoder network (1321) are updated parameters according to the online training based encoder tuning operation.

During the encoding operation, in some examples, for the input image x₀, the main encoder network (1311) generates a latent representation y₀′ from the input image x₀. The latent representation y₀′ can be quantized using the quantizer (1312) to generate a quantized latent [symbol] ′. The quantized latent [symbol] ′ can be compressed, for example, using lossless compression by the entropy encoder (1313) to generate the compressed image (e.g., an encoded image) [symbol] ′ (1331) that is a compressed representation [symbol] ′ of the input image x₀.

The latent representation y₀′ can be fed into the hyper encoder network (1321) to generate a hyper latent z₀′. The hyper latent z₀′ is quantized by the quantizer (1322) to generate a quantized latent [symbol] . The quantized latent [symbol] ′ can be compressed, for example, using lossless compression by the entropy encoder (1323) to generate side information, such as encoded bits (1332).

The side information, such as the encoded bits (1332), can be decompressed (e.g., entropy decoded) by the entropy decoder (1324) to generate the quantized latent [symbol] ′. The hyper decoder network (1325) can decode the quantized latent [symbol] ′ to generate the output oₑₚ. The output oₑₚ can be provided to the entropy encoder (1313) to determine entropy model.

In an example, the compressed image (e.g., an encoded image) [symbol] ′ (1331) and the encoded bits (1332) can be put in a bitstream for carrying the input image x₀. In an example, the bitstream is stored and later retrieved and decoded by the electronic device (1300). In another example, the bitstream is transmitted to other devices, and the other devices can perform the decoding operation.

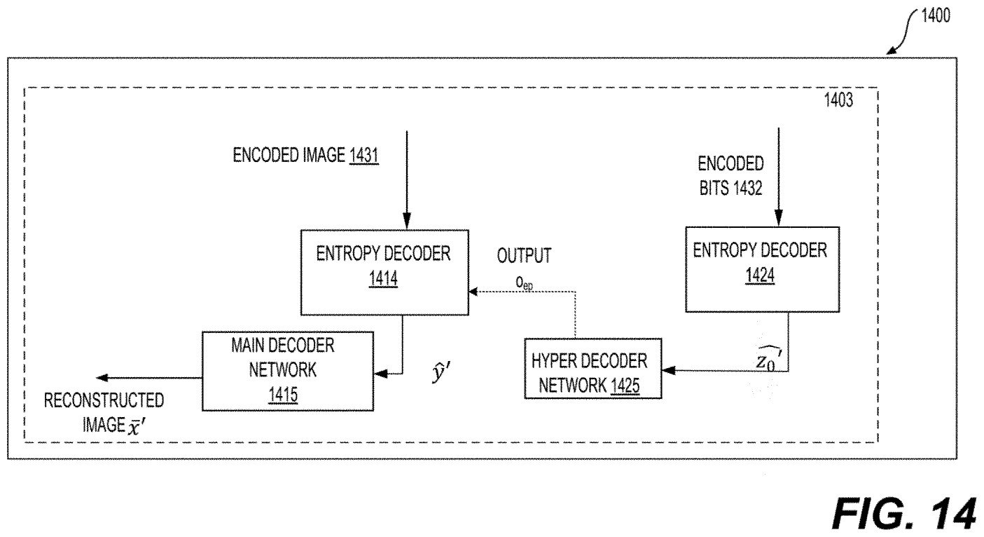

FIG. 14 shows a diagram of components in an electronic device (1400) to perform the decoding operation for the input image x₀ according to some aspects of the disclosure. The electronic device (1400) can be any suitable device, such as a server computer, a desktop computer, a laptop computer, and the like. In an example, the electronic device (1400) is the electronic device (1300). In another example, the electronic device (1400) is a different device from the electronic device (1300).

The electronic device (1400) includes a neural network based image decoder (1403) that includes an entropy decoder (1414), a main decoder network (1415), an entropy decoder (1424), and a hyper decoder network (1425). The entropy decoder (1414) can correspond to entropy decoder (1314) (e.g., with same structure and same parameters) and is similarly configured as the entropy decoder (114), the main decoder network (1415) can correspond to the main decoder network (1315) (e.g., with same structure and same parameters) and is similarly configured as the main decoder network (115), the entropy decoder (1424) can correspond to the entropy decoder (1324) (e.g., with same structure and same parameters) and is similarly configured as the entropy decoder (124), and the hyper decoder network (1425) can correspond to the hyper decoder network (1325) (e.g., with same structure and same parameters) and is similarly configured as the hyper decoder network (125). The description has been provided above with reference to FIG. 1 and will be omitted herein for clarity.

It is noted that, in some examples, parameters in the neural networks of the neural network based image decoder (1403) are pretrained parameters.

During the decoding operation, in some examples, a bitstream carrying the compressed representation [symbol] ′ of the input image x₀ and side information is received and parsed into the encoded image (1431) and the encoded bits (1432). The encoded image (1431) can be decompressed (e.g., entropy decoded) by the entropy decoder (1414) to generate the quantized latent [symbol] ′. The main decoder network (1415) can decode the quantized latent [symbol] ′ to generate the reconstructed image x̅₀̅′.

The encoded bits (1432) can be decompressed (e.g., entropy decoded) by the entropy decoder (1424) to generate the quantized latent [symbol] ′. The hyper decoder network (1425) can decode the quantized latent [symbol] ′ to generate the output oₑₚ. The output oₑₚ can be provided to the entropy decoder (1414) to determine entropy model.

It is noted that the online training based encoder tuning operation makes changes at the encoder side, and the decoder related operations require no changes.

In some embodiments, during the online training based encoder tuning operation, all the parameters in the main encoder network (1311) and the hyper encoder network (1321) are tuned and optimized.

In some embodiments, only a portion of the parameters in the main encoder network (1311) and/or the hyper encoder network (1321) is tuned and optimized. In some examples, parameters in some layers in the main encoder network (1311) and/or the hyper encoder network (1321) are tuned. In some examples, parameters of one or more channels in a layer in the main encoder network (1311) and/or the hyper encoder network (1321) are tuned.

In some examples, an input image is first split into blocks to compress by blocks. The step size for each block can be different. In some examples, different step sizes are assigned to blocks of an image to achieve better compression result.

In an example that images are compressed without splitting to blocks, different images may have different step sizes to achieve optimized compression result. In some examples, different step sizes can be assigned to an image based on features (e.g., a smoothness, complicity, and the like) in the image. In some examples, different step sizes can be assigned to an image based on a type of the image.

It is noted that the update from the online training includes changes to parameters only in the encoding portion, and the parameters of the decoding portion are fixed. Thus, the encoded image can be decoded by a same image decoder with pretrained parameters from the offline training in some examples. The online training exploits the optimized encoder mechanisms to improve the NIC coding efficiency, and can be flexible and the general framework can accommodate various types of quality metrics.

Further, some aspects of the disclosure provide techniques for online training based encoder tuning with multi model selection in neural image compression (NIC).

In some examples, multiple encoders/decoders are available in an image coding system to compress an image/block. For example, during the encoding phase, at an encoding device in the image coding system, all the encoders in an encoder set can be candidates to compress an input image. One encoder with the best optimization result (e.g., least rate distortion loss) can be chosen from the encoder set, and the chosen encoder is used to compress the input image into a bitstream. Further, an index indicative of the chosen encoder can be signaled, for example in the bitstream, to a decoding device in the image coding system. The decoding device can choose, based on the index, a decoder corresponding to the chosen encoder from a decoder set of decoders. The chosen decoder is then used to decode the bitstream.

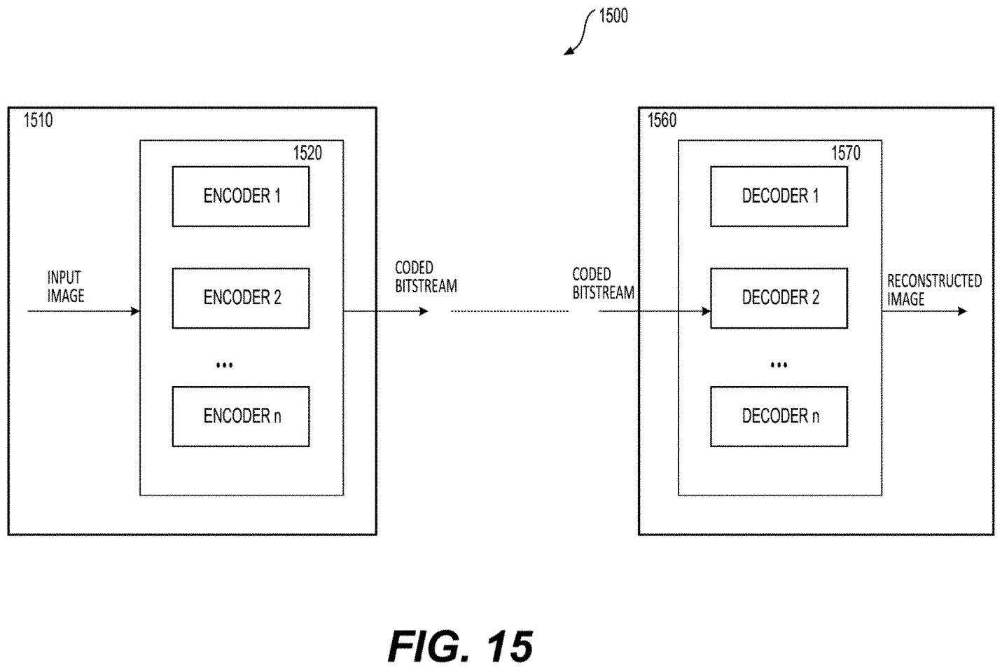

FIG. 15 shows an image coding system (1500) in some examples. The image coding system (1500) includes an encoding device (1510) and a decoding device (1560). The encoding device (1510) includes an encoding set (1520) that includes a plurality of encoders. The decoding device (1560) includes a decoding set (1570) that includes a plurality of decoders. The plurality of decoders can correspond to the plurality of encoders. For example, decoder 1 corresponds to encoder 1, thus decoder 1 can decode a coded bitstream that is encoded by the encoder 1; decoder 2 corresponds to encoder 2, thus decoder 2 can decode a coded bitstream that is encoded by the encoder 2. In some examples, the plurality of encoders and the plurality of decoders are encoders/decoders of NIC frameworks. In some examples, the plurality of encoders may include non NIC based encoders, and the plurality of decoders may include non NIC based decoders.

In some examples, the encoding device (1510) receives an input image. The encoding device (1510) can select one of the encoders in the encoder set (1520) to encode the input image. For example, the encoding device (1510) can choose an encoder with the best optimization result (e.g., least rate distortion loss) among the encoders in the encoder set (1520). The chosen encoder is used to compress the input image into a coded bitstream. Further, an index indicative of the chosen encoder can be signaled, for example in the coded bitstream. The coded bitstream can be transmitted to the decoding device (1560). The decoding device can extract the index from the coded bitstream, and then based on the index, the decoding device (1560) can determine a decoder from the decoder set (1570). The decoder corresponds to the chosen encoder at the encoding device (1510). The determined decoder is then used to decode the coded bitstream to generate a reconstructed image.

According to some aspects of the disclosure, the encoders in encoder set (1520) can be pretrained NIC encoders of pretrained NIC frameworks and the decoders in the decoder set (1570) can be pretrained NIC decoders of the pretrained NIC frameworks. For example, encoder 1 and decoder 1 are pretrained NIC encoder and pretrained NIC decoder of a first pretrained NIC framework (e.g., a first NIC model), and encoder 1 and decoder 2 are pretrained NIC encoder and pretrained NIC decoder of a second pretrained NIC framework (e.g., a second NIC model). In some examples, the different pretrained NIC frameworks can have the same network structure but with different pretrained parameters. In some examples, the different pretrained NIC frameworks can have different network structures. In some examples, the pretrained NIC frameworks can be configured to have respective preferences on coding images. For example, the first pretrained NIC framework can achieve better compression results on images with certain characteristics (e.g., person portrait, mountain scenery, and the like) than other pretrained NIC frameworks.

In some examples, parameters of the pretrained NIC frameworks are trained by using different sets of training data with different characteristics. For example, parameters in the first pretrained NIC framework are trained (e.g., pretrained) using a set of training images of person portraits, and parameters in the second pretrained NIC framework are trained (e.g., pretrained) using a set of training images of mountain scenery.

In some examples, for an input image, online training based encoder tuning can be performed on the pretrained NIC frameworks to select a pretrained NIC framework that can achieve a lowest rate distortion loss with online training based encoder tuning.

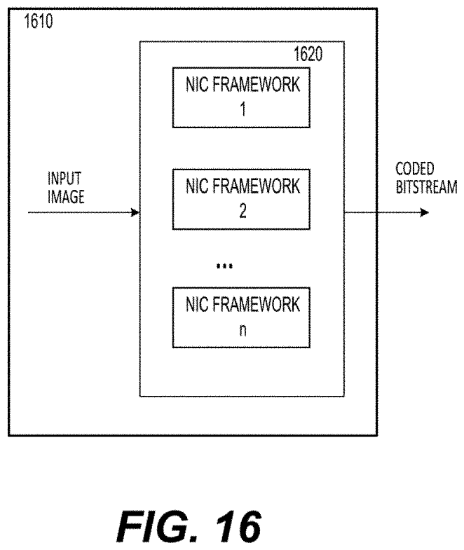

FIG. 16 shows an encoding device (1610) in some examples. The encoding device (1610) includes a set of NIC frameworks that are pretrained. The encoding device (1610) receives an input image. Based on the input image, online training based encoder tuning is respectively performed on each of the NIC frameworks. Then, an NIC framework that can achieve a least loss (e.g., a least rate loss, a least distortion loss, a least rate distortion loss) with the online training based encoder tuning is selected. Then, the tuned encoder of the selected NIC framework is used to encode the input image in a coded bitstream. In an example, an index that indicates the selected NIC framework can be included in the coded bitstream.

In an example, when the coded bitstream is received at a decoding device, such as the decoding device (1560), the decoding device can extract the index from the coded bitstream. Based on the index, a decoder of the selected NIC network is selected from a decoder set. The selected decoder can decode the coded bitstream and generate a reconstructed image accordingly.

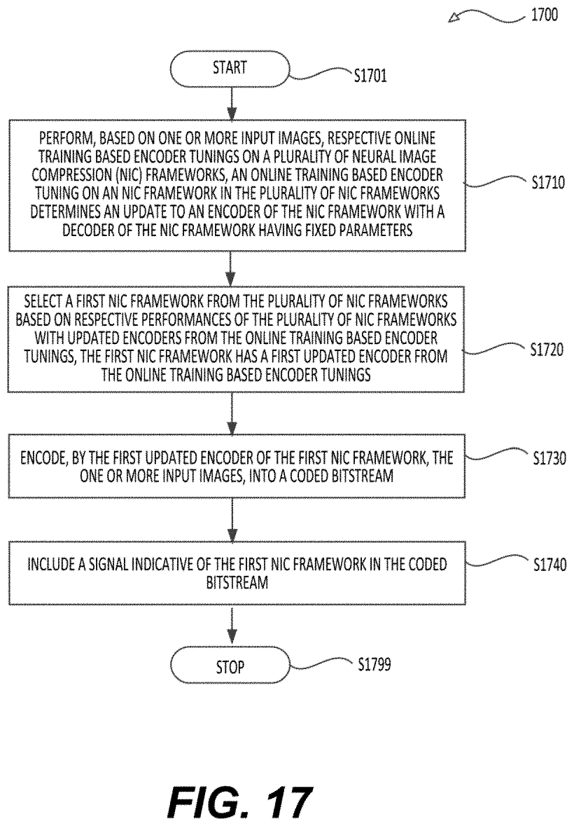

FIG. 17 shows a flow chart outlining a process (1700) according to an embodiment of the disclosure. The process (1700) is an encoding process that includes an online training based encoder tuning of an NIC framework. The process (1700) can be executed in an electronic device, such as the encoding device (1610) in an example. In some embodiments, the process (1700) is implemented in software instructions, thus when the processing circuitry executes the software instructions, the processing circuitry performs the process (1700). The process starts at (S1701), and proceeds to (S1710).

At (S1710), based on one or more input images, respective online training based encoder tunings are performed on a plurality of neural image compression (NIC) frameworks. An online training based encoder tuning on an NIC framework in the plurality of NIC frameworks determines an update to an encoder of the NIC framework with a decoder of the NIC framework having fixed parameters.

At (S1720), a first NIC framework is selected from the plurality of NIC frameworks based on respective performances of the plurality of NIC frameworks with updated encoders from the online training based encoder tunings. The first NIC framework has a first updated encoder from the online training based encoder tunings.

At (S1730), the first updated encoder of the first NIC framework is used to encode the one or more input images into a coded bitstream.

At (S1740), a signal indicative of the first NIC framework is included in the coded bitstream.

In some examples, the encoder of the NIC framework includes a main encoder network, a hyper encoder network and a hyper decoder network, and the decoder of the NIC framework includes the hyper decoder network and a main decoder network. In an example, the update to the encoder of the NIC framework includes at least a value change to a tunable parameter in at least one of the main encoder network and the hyper encoder network. In some examples, parameters of the main decoder network and the hyper decoder network are fixed at pretrained values learned from an offline training of the NIC framework.

In some examples, the plurality of NIC frameworks form a set of NIC frameworks, and the signal includes an index indicative of the first NIC framework in the set of NIC frameworks.

In some examples, at least two NIC frameworks in the plurality of NIC frameworks have different neural network structures.

In some examples, at least two NIC frameworks in the plurality of NIC frameworks have a same network structure, and have different pretrained parameters.

In some examples, at least two NIC frameworks in the plurality of NIC frameworks are pretrained based on different sets of training data.

In some examples, the first NIC framework is selected in response to the first NIC framework with the first updated encoder achieving a least loss performance. The least loss performance includes at least one of a least rate loss, a least distortion loss, and a least rate distortion loss.

Then, the process (1700) proceeds to (S1799) and terminates.

The process (1700) can be suitably adapted to various scenarios and steps in the process (1700) can be adjusted accordingly. One or more of the steps in the process (1700) can be adapted, omitted, repeated, and/or combined. Any suitable order can be used to implement the process (1700). Additional step(s) can be added.

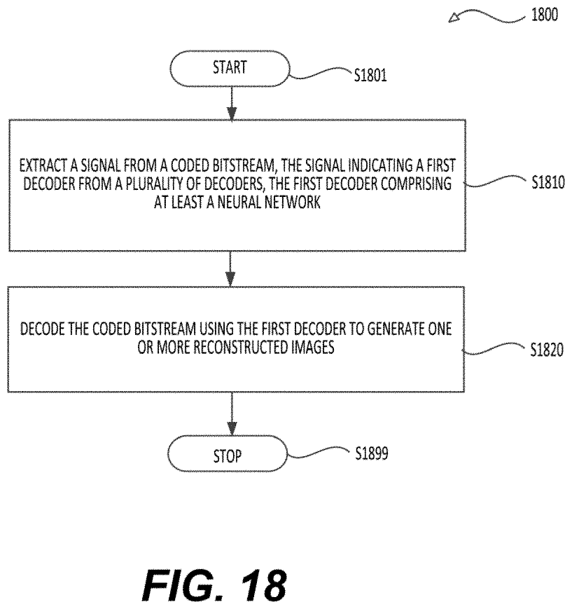

FIG. 18 shows a flow chart outlining a process (1800) according to an embodiment of the disclosure. The process (1800) is a decoding process that can decode a coded bitstream that is encoded based on an online training based encoder tuning of an NIC framework. The process (1800) can be executed in an electronic device, such as the decoding device (1560) in an example. In some embodiments, the process (1800) is implemented in software instructions, thus when the processing circuitry executes the software instructions, the processing circuitry performs the process (1800). The process starts at (S1801), and proceeds to (S1810).

At (S1810), a signal is extracted from a coded bitstream, the signal indicates a decoder from a plurality of decoders. The decoder is a neural network based decoder that includes at least a neural network. In an example, the decoding device (1560) extracts an index from the coded bitstream, and the index indicates a decoder from the decoder set (1570).

At (S1820), the coded bitstream is decoded by the decoder to generate one or more reconstructed images. In some examples, the coded bitstream is encoded by an encoder corresponding to the decoder at an encoding device. The encoder is selected from an encoder set based on online training based encoder tuning. For example, the encoding device includes a set of NIC frameworks. When one or more input images are received for encoding at the encoding device, the NIC frameworks are respectively optimized according to the online training based encoder tuning. Then, one of the NIC frameworks that achieves a least loss performance with the online training based encoder tuning is selected, and the tuned encoder of the selected NIC framework is used to encode the one or more input image into the coded bitstream. Because the decoder of the selected NIC framework has fixed parameters (e.g., fixed pretrained parameters) during the online training based encoder tuning, thus when the corresponding decoder at the decoding device (1560) is selected according to the index, the selected decoder at the decoding device has the same network structure and the same parameters as the decoder of the selected NIC framework at the encoding device, and thus can decode the coded bitstream, and generate the one or more reconstructed images.

Then, the process (1800) proceeds to (S1899) and terminates.

The process (1800) can be suitably adapted to various scenarios and steps in the process (1800) can be adjusted accordingly. One or more of the steps in the process (1800) can be adapted, omitted, repeated, and/or combined. Any suitable order can be used to implement the process (1800). Additional step(s) can be added.

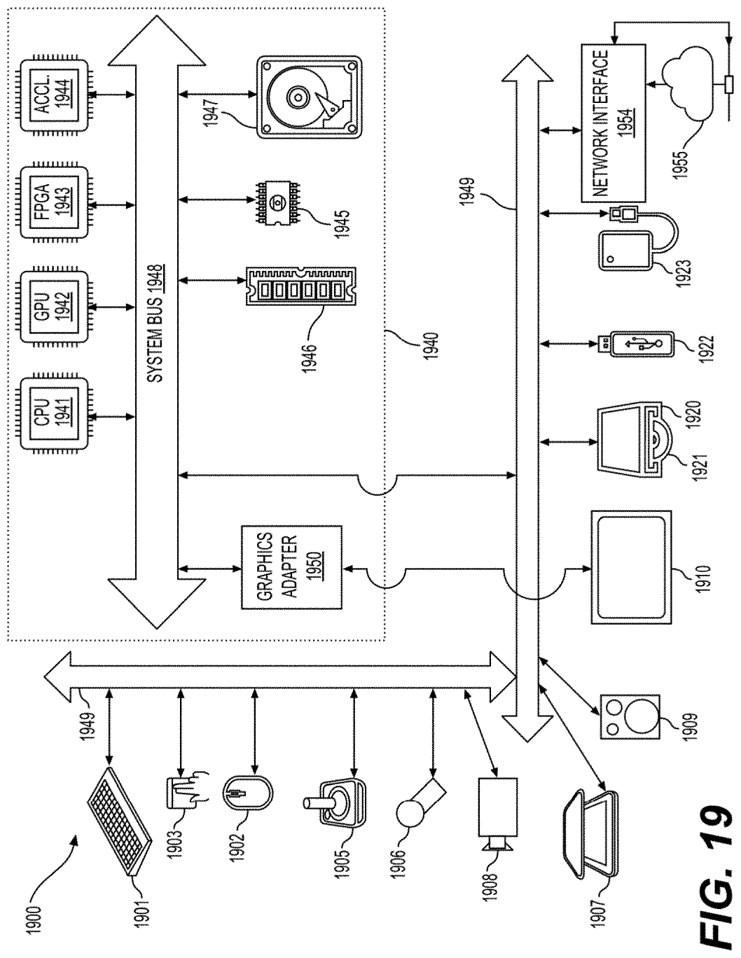

The techniques described above, can be implemented as computer software using computer-readable instructions and physically stored in one or more computer-readable media. For example, FIG. 19 shows a computer system (1900) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 19 for computer system (1900) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1900).

Computer system (1900) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1901), mouse (1902), trackpad (1903), touch screen (1910), data-glove (not shown), joystick (1905), microphone (1906), scanner (1907), camera (1908).

Computer system (1900) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1910), data-glove (not shown), or joystick (1905), but there can also be tactile feedback devices that do not serve as input devices), audio output devices (such as: speakers (1909), headphones (not depicted)), visual output devices (such as screens (1910) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (1900) can also include human accessible storage devices and their associated media such as optical media including CD/DVD ROM/RW (1920) with CD/DVD or the like media (1921), thumb-drive (1922), removable hard drive or solid state drive (1923), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1900) can also include an interface (1954) to one or more communication networks (1955). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1949) (such as, for example USB ports of the computer system (1900)); others are commonly integrated into the core of the computer system (1900) by attachment to a system bus as described below (for example Ethernet interface into a PC computer system or cellular network interface into a smartphone computer system). Using any of these networks, computer system (1900) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1940) of the computer system (1900).

The core (1940) can include one or more Central Processing Units (CPU) (1941), Graphics Processing Units (GPU) (1942), specialized programmable processing units in the form of Field Programmable Gate Areas (FPGA) (1943), hardware accelerators for certain tasks (1944), graphics adapters (1950), and so forth. These devices, along with Read-only memory (ROM) (1945), Random-access memory (1946), internal mass storage such as internal non-user accessible hard drives, SSDs, and the like (1947), may be connected through a system bus (1948). In some computer systems, the system bus (1948) can be accessible in the form of one or more physical plugs to enable extensions by additional CPUs, GPU, and the like. The peripheral devices can be attached either directly to the core's system bus (1948), or through a peripheral bus (1949). In an example, the screen (1910) can be connected to the graphics adapter (1950). Architectures for a peripheral bus include PCI, USB, and the like.

CPUs (1941), GPUs (1942), FPGAs (1943), and accelerators (1944) can execute certain instructions that, in combination, can make up the aforementioned computer code. That computer code can be stored in ROM (1945) or RAM (1946). Transitional data can be also be stored in RAM (1946), whereas permanent data can be stored for example, in the internal mass storage (1947). Fast storage and retrieve to any of the memory devices can be enabled through the use of cache memory, that can be closely associated with one or more CPU (1941), GPU (1942), mass storage (1947), ROM (1945), RAM (1946), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1900), and specifically the core (1940) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1940) that are of non-transitory nature, such as core-internal mass storage (1947) or ROM (1945). The software implementing various embodiments of the present disclosure can be stored in such devices and executed by core (1940). A computer-readable medium can include one or more memory devices or chips, according to particular needs. The software can cause the core (1940) and specifically the processors therein (including CPU, GPU, FPGA, and the like) to execute particular processes or particular parts of particular processes described herein, including defining data structures stored in RAM (1946) and modifying such data structures according to the processes defined by the software. In addition or as an alternative, the computer system can provide functionality as a result of logic hardwired or otherwise embodied in a circuit (for example: accelerator (1944)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for image encoding, comprising:
performing, based on one or more input images, respective online training based encoder tunings on a plurality of neural image compression (NIC) frameworks, each of the plurality of NIC framework corresponding to an end-to-end NIC model with a respective encoder and a respective decoder, an online training based encoder tuning on an NIC framework in the plurality of NIC frameworks determining an update to an encoder of the NIC framework with a decoder of the NIC framework having fixed parameters;
selecting a first NIC framework from the plurality of NIC frameworks based on respective performances of the plurality of NIC frameworks with updated encoders from the online training based encoder tunings, the first NIC framework having a first updated encoder from the online training based encoder tunings;
encoding, by the first updated encoder of the first NIC framework, the one or more input images, into a coded bitstream; and
including a signal indicative of the first NIC framework in the coded bitstream.

2. The method of claim 1, wherein the encoder of the NIC framework comprises a main encoder network, a hyper encoder network and a hyper decoder network, and the decoder of the NIC framework comprises the hyper decoder network and a main decoder network.

3. The method of claim 2, wherein the update to the encoder of the NIC framework comprises at least a value change to a tunable parameter in at least one of the main encoder network and the hyper encoder network.

4. The method of claim 2, wherein parameters of the main decoder network and the hyper decoder network are fixed at pretrained values learned from an offline training of the NIC framework.

5. The method of claim 1, wherein the plurality of NIC frameworks form a set of NIC frameworks, and the signal comprises an index indicative of the first NIC framework in the set of NIC frameworks.

6. The method of claim 1, wherein at least two NIC frameworks in the plurality of NIC frameworks have different neural network structures.

7. The method of claim 1, wherein at least two NIC frameworks in the plurality of NIC frameworks have a same network structure, and have different pretrained parameters.

8. The method of claim 1, wherein at least two NIC frameworks in the plurality of NIC frameworks are pretrained based on different sets of training data.

9. The method of claim 1, wherein the selecting the first NIC framework further comprises:
selecting the first NIC framework in response to the first NIC framework with the first updated encoder achieving a least loss performance.

10. The method of claim 9, wherein the least loss performance comprises at least one of a least rate loss, a least distortion loss, and a least rate distortion loss.

11. An apparatus for image encoding, comprising processing circuitry configured to:
perform, based on one or more input images, respective online training based encoder tunings on a plurality of neural image compression (NIC) frameworks, each of the plurality of NIC framework corresponding to an end-to-end NIC model with a respective encoder and a respective decoder, an online training based encoder tuning on an NIC framework in the plurality of NIC frameworks determining an update to an encoder of the NIC framework with a decoder of the NIC framework having fixed parameters;
select a first NIC framework from the plurality of NIC frameworks based on respective performances of the plurality of NIC frameworks with updated encoders from the online training based encoder tunings, the first NIC framework having a first updated encoder from the online training based encoder tunings;
encode, by the first updated encoder of the first NIC framework, the one or more input images, into a coded bitstream; and
include a signal indicative of the first NIC framework in the coded bitstream.

12. The apparatus of claim 11, wherein the encoder of the NIC framework comprises a main encoder network, a hyper encoder network and a hyper decoder network, and the decoder of the NIC framework comprises the hyper decoder network and a main decoder network.

13. The apparatus of claim 12, wherein the update to the encoder of the NIC framework comprises at least a value change to a tunable parameter in at least one of the main encoder network and the hyper encoder network.

14. The apparatus of claim 12, wherein parameters of the main decoder network and the hyper decoder network are fixed at pretrained values learned from an offline training of the NIC framework.

15. The apparatus of claim 11, wherein the plurality of NIC frameworks form a set of NIC frameworks, and the signal comprises an index indicative of the first NIC framework in the set of NIC frameworks.

16. The apparatus of claim 11, wherein at least two NIC frameworks in the plurality of NIC frameworks have different neural network structures.

17. The apparatus of claim 11, wherein at least two NIC frameworks in the plurality of NIC frameworks have a same network structure, and have different pretrained parameters.

18. The apparatus of claim 11, wherein at least two NIC frameworks in the plurality of NIC frameworks are pretrained based on different sets of training data.

19. The apparatus of claim 11, wherein the processing circuitry is configured to:
select the first NIC framework in response to the first NIC framework with the first updated encoder achieving a least loss performance.

20. The apparatus of claim 19, wherein the least loss performance comprises at least one of a least rate loss, a least distortion loss, and a least rate distortion loss.
